(19) United States
(12) Patent Application Publication
(10) Pub. No.: US 2002/0018868 A1
(43) Pub. Date: Feb. 14, 2002

(54) Textured image laminating film

(76) Inventor: Han Chil Choi, Etobicoke (CA)

Correspondence Address: Russell D. Orkin, WEBB ZIESENHEIM LOGSDON ORKIN & HANSON, P.C., 700 Koppers Building, 436 Seventh Avenue, Pittsburgh, PA, 15219-1818, US

(21) Appl. No.: 09/873,940

(22) Filed: Jun. 4, 2001

(30) Foreign Application Priority Data
Jun. 5, 2000 (CA) 2, 310, 198

(51) Int. Cl. B32B 7/06; B05D 5/10

(52) U.S. Cl. 428/40.1; 428/142; 428/172; 427/208.4

(57) ABSTRACT

A method of forming an image laminating film. The method comprises applying an adhesive to one surface of a polymer film, applying an acrylic gel to the opposed surface of the polymer film, imprinting a texture to the acrylic gel and then drying the acrylic gel to retain the textured surface, and coating a transparent protective layer on the surface of the gel. The textured film may be laminated over an image to provide texture to the surface of the image.

### FIELD OF THE INVENTION

The present invention relates to a textured image laminating film, and especially to a method of forming such a film. In addition, the present invention relates to a method of applying a textured surface to an image e.g. a print, and to the resultant print with textured surface.

### BACKGROUND TO THE INVENTION

Oil paintings have an appeal to a significant portion of the population. While a substantial part of the appeal is in the subject matter of the oil painting, and the skill with which the oil painting has been applied to a surface, at least part of the appeal lies in the texture of the surface of the oil painting. To many people, oil paintings have a character that is not present in various kinds of prints. Thus, whereas photographic prints, prints formed by a variety of printing techniques and other images may be of high quality in a technical sense or have significant appeal for other reasons, such prints lack the perceived quality of an oil painting.

Techniques have been developed for stripping a photograph or lithograph from a substantial portion of its backing followed by the bonding of the photograph or lithograph to a textured backing at elevated temperatures and pressure, to provide an image with a textured surface. Such a process is described in U.S. Pat. No. 4,528,233. Processes for making tri-dimensional photographs, known as photoreliefography, are described in U.S. Pat. No. 3,772,106. A process for producing an image on canvas or other backing in which a thin acrylic polymer continuous self-supporting film is formed, with an image being formed subsequently on the surface of the film, is described in U.S. Pat. No. 3,589,955. It is also known to laminate a protective layer on a photograph to extend the life of the photograph and prevent gradual deterioration due to environmental conditions, as disclosed in U.S. Pat. No. 4,378,392.

Techniques for producing a textured surface on a print, poster, photograph, water colour print, or other image in an economical manner are still required.

Methods have now been found for forming a textured image laminating film, and for forming textured laminated images, as well as the film and the prints thus obtained.

### SUMMARY OF THE INVENTION

Accordingly, one aspect of the present invention provides a method of forming an image laminating film comprising:

a) applying an adhesive to one surface of a polymer film, said film being transparent and capable of being bonded to acrylic polymers;

b) applying a clear acrylic gel to the opposed surface of the polymer film;

c) imprinting a texture to said clear acrylic gel;

d) heating said textured acrylic gel to dry said gel and retain the textured surface, the dried gel being transparent; and

e) applying to the surface of the gel an aqueous solution of a coating that forms a transparent protective layer conforming to the textured surface,

said adhesive being selected so that the image laminating film so obtained is transparent.

In a preferred embodiment of the method of the present invention, the coating of the protective layer is an acrylic coating, having a gloss or matte surface.

In a further embodiment, the coating of step (e) is dried at ambient temperature.

In another preferred embodiment, the adhesive and protective layer are selected so that the image laminating film is colourless and transparent.

In yet another embodiment, the acrylic gel applied in step (b) is an acrylic gloss gel.

In a still further embodiment of the present invention, a peelable release sheet is applied to the adhesive on the one surface of the polymer film, especially prior to applying the acrylic gel. The adhesive is preferably a pressure-sensitive adhesive.

In another embodiment, the polymer film of step (a) is a polyolefin film, especially polypropylene film.

In a further aspect of the present invention, there is provided an image laminating film comprising:

a) an adhesive layer on one surface of a polymer film;

b) a transparent acrylic gel on the opposed surface of the polymer film, said gel having a textured surface imprinted therein and having being dried; and

c) a transparent protective layer on the gel, the transparent protective layer being a coating,

the adhesive being selected so that the image laminating film is transparent.

In a preferred embodiment of the image laminating film of the present invention, a release sheet is laminated to the adhesive surface on the polymer film, the adhesive preferably being a pressure-sensitive adhesive.

In another preferred embodiment, the adhesive and protective layer are selected so that the image laminating film is colourless and transparent.

A further aspect of the present invention provides a method of providing texture to the surface of an image on a substrate comprising of:

a) forming a sandwich of said substrate and a transparent textured film, said textured film having opposed surfaces with an adhesive on one surface and a protective coating on the opposed surface, said adhesive being a pressure-sensitive adhesive and being placed in contact with the image on said substrate; and

b) applying pressure for a period of time to effect bonding of the textured film to the image and substrate.

An additional aspect of the present invention provides a laminate of an image on a substrate, said image having laminated thereto, in sequence, an adhesive, a textured film formed from an acrylic gel and a protective coating.

In a preferred embodiment of the laminated image on a substrate, the image is in the form of a photograph, print, poster, water coloured painting or image transferred onto canvas.

In another embodiment, the substrate is canvas, batik, hardboard, masonite, foam sheet, foam core or clipboard.

In another embodiment, the protective layer has a matte finish or a gloss finish.

### BRIEF DESCRIPTION OF THE DRAWINGS The present invention is illustrated by the embodiments shown in the drawings, in which:

FIG. 1 is a schematic representation of a texturing process;

FIG. 2 is a schematic representation of a textured laminate;

FIG. 3 is a schematic representation of laminating of a print to a substrate; and

FIG. 4 is a photocopier reproduction of a portion of a colour print after lamination according to the invention.

### DETAILED DESCRIPTION OF THE INVENTION

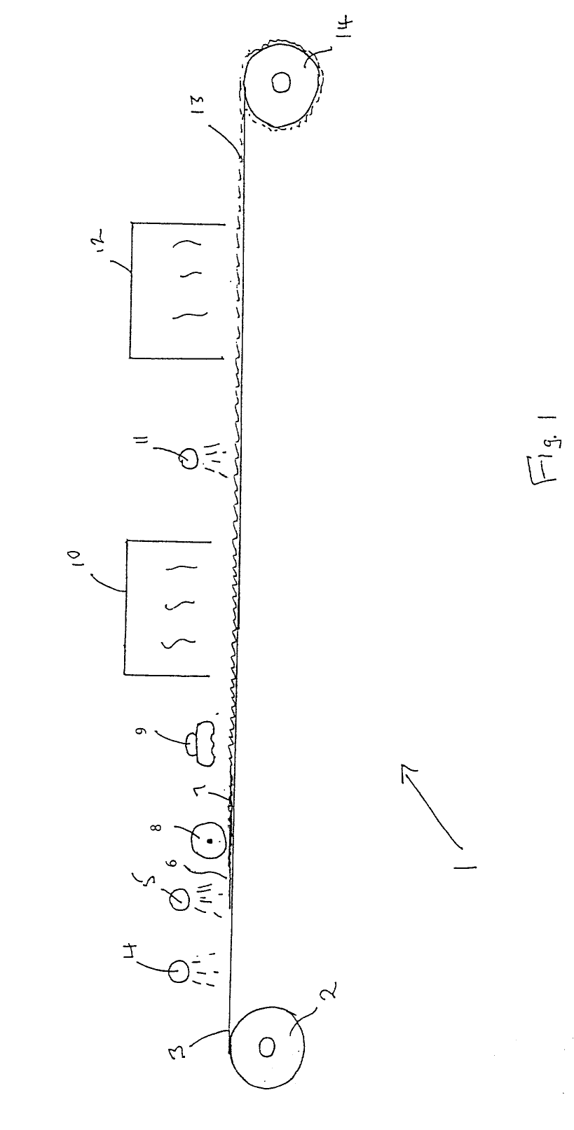

FIG. 1 shows a texturing process, generally indicated by 1. Texturing process 1 has polymer film roll 2 from which polymer film 3 is unwound. Polymer film 3 passes first adhesive roller 4, at which adhesive is rolled onto polymer film 3. Such adhesive may be a heat-activated adhesive for bonding of the film to the substrate, but is preferably a pressure-sensitive adhesive.

Release film 6 is unwound from release film roll 5. Polymer film 3 with adhesive thereon is brought into contact with release film 6 to form first laminate 7. First laminate 7 is in the form of release film 6 in contact with polymer film 3, with adhesive at the interface. At this stage in the process, polymer film 3 and release film 6 are in a peelable state.

First laminate 7 is then passed by acrylic gel roller 8, at which the acrylic gel is rolled onto the upper surface of first laminate 7 i.e. it is rolled on the surface opposed to release film 6. First laminate 7 is then passed by texturing apparatus 9. In the embodiment shown in FIG. 1, texturing apparatus 9 is in the form of a press with a textured surface, but it is preferred that texturing apparatus 9 be in the form of rollers or stamping apparatus, or the like, having a textured surface and adapted to imprint the texturing onto the acrylic gel. Thus, for instance, the texturing apparatus could consist of two or more rollers e.g. 6-10 rollers, through which the first laminate 7 is passed, the roller in contact with the acrylic gel having a textured surface.

First laminate 7 with the textured acrylic gel on the surface thereof is then passed through oven 10 at which stage the acrylic gel is dried. For instance, the period of drying might be 5-10 minutes at 65-95° C.

An aqueous coating is applied at roller 11. The aqueous coating is selected such that, after drying, it forms a transparent protective coating on the acrylic gel. The coating is preferably an acrylic coating. The coating when dried may have a gloss finish or a matte finish. It is intended that the coating would at least substantially retain the texture of the gel.

The aqueous coating is dried in oven 12. Oven 12 may be a heated oven, at a temperature that does not adversely affect the acrylic gel, but is preferably operated at or about ambient temperature e.g. using fans or the like. Oven 12 needs to be operated in a manner to effect drying of the coating.

The resultant textured film 13, with dried coating, is wound on roller 14. Alternatively, the film may be cut to a suitable size e.g. 36″×48″, in which case the resultant sheets would likely be stacked.

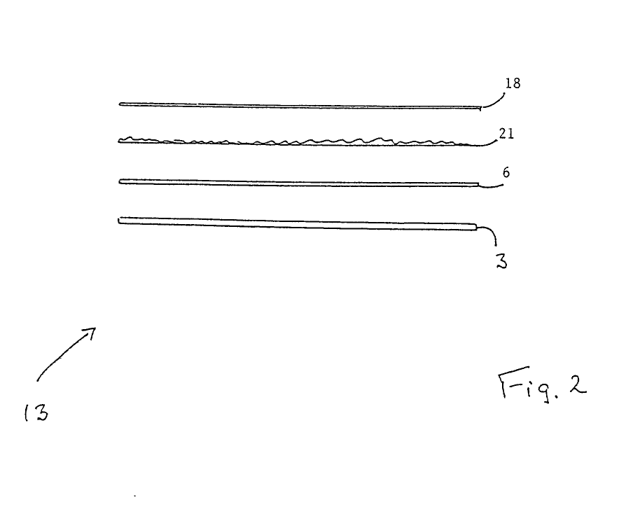

The laminate formed in the process of FIG. 1 is shown schematically in FIG. 2. FIG. 2 is an exploded view of the laminate for ease of viewing. Starting from the bottom of the laminate, the first layer 6 is the release film, adjacent from which in sequence are adhesive 4, polymer film 3, textured acrylic gel 21 and coating 18. It is understood that textured acrylic gel layer 21 is formed from the acrylic gel spray 8, as described with reference to FIG. 1. All of the layers of laminate of FIG. 1 are bonded together to form a single laminate, except for release layer 6 which is peelable from the laminate, before use of the laminate.

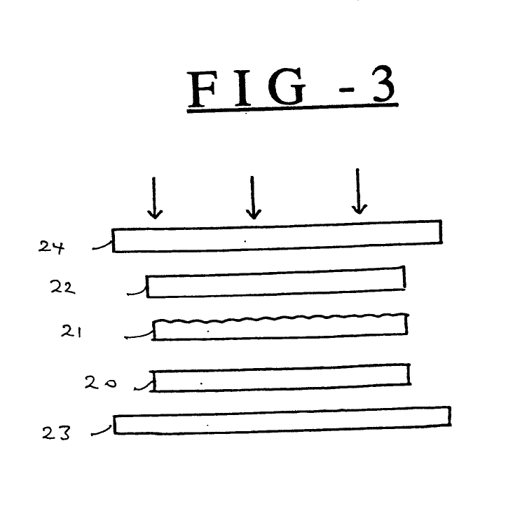

An embodiment of forming a laminated image is shown in FIG. 3. A sandwich is formed of a print 20, textured film 21 and sponge pad 22. The sandwich is placed between lower press plate 23 and upper press plate 24. The upper press plate 24 is then lowered, so that pressure is applied to the laminate between upper press plate and lower press plate 23. It is understood that one or both of the press plates 23 and 24 could be heated to a controlled temperature suitable for the lamination process, the temperature being controlled to effect lamination but not adversely affect the quality of the print. However, it is preferred that a pressure-sensitive adhesive be used, in which event press plates 23 and 24 would not be heated. After a period of time, usually a controlled period of time, the upper press plate 24 is moved away from lower press plate 23 and the resultant laminated textured print is removed. In another embodiment, the press may be a vacuum press.

In the process of FIG. 3, the sponge pad is particularly used to protect the laminate that is being formed. Such use of sponge pads is known, but a variety of other protective layers may be used.

In other embodiments, the sandwich of print and image laminating film could be passed through rollers to effect the lamination process.

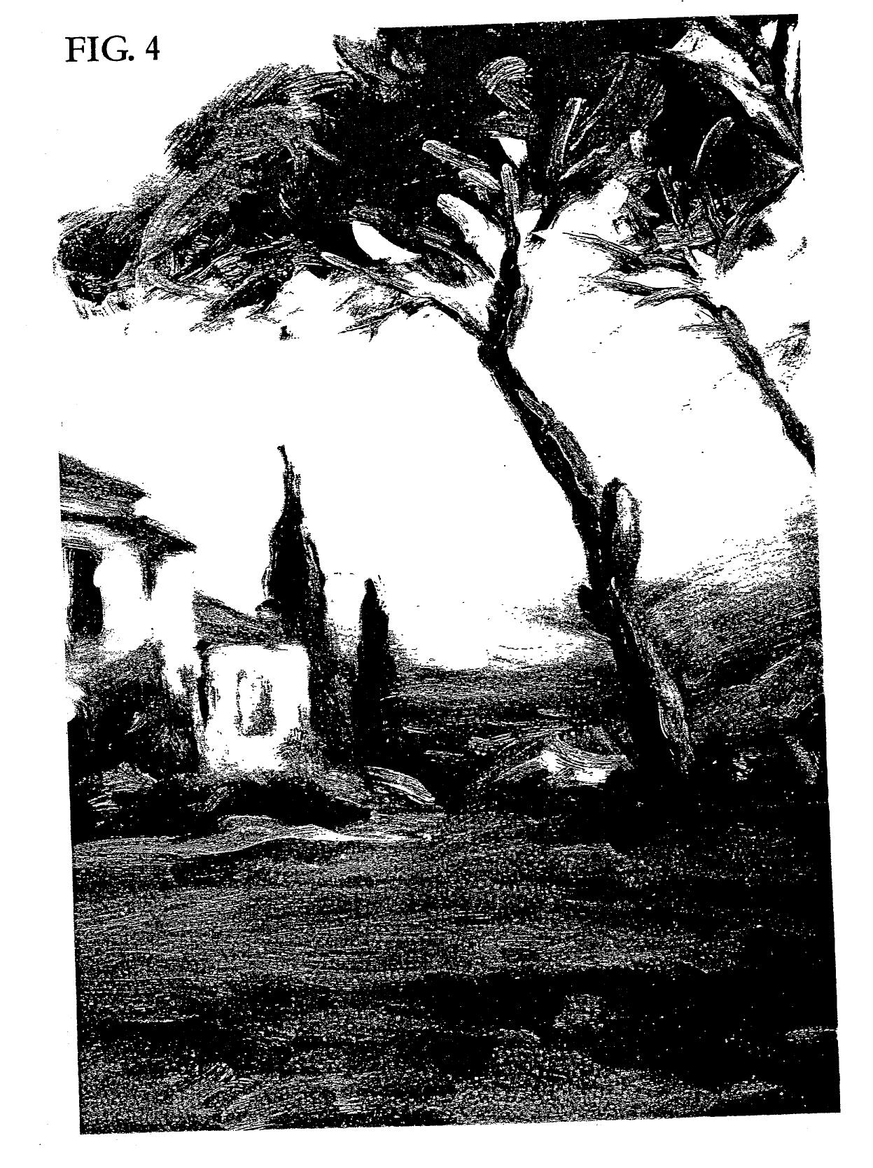

FIG. 4 is a photocopier representation of a portion of a colour print after lamination with an image texturing film according to the invention. The print after lamination exhibits texture and an impression more closely resembling that of an oil painting.

The release film may be selected from a variety of films having release properties from its adjacent adhesive. The release film would have the properties understood for such a film, including being peelable prior to use. Examples of such films include wax and silicone coated papers.

The polymer film is a transparent film that may be bonded to the acrylic gel and to the image and substrate. The polymer film must have the ability to adhere to the acrylic gel, as well as not adversely affecting the quality of the print in any significant manner over a period of time, preferably over a period of several years. Examples of such films include polyvinyl chloride, polyvinylidene chloride (saran), polyolefins e.g. polyethylene and polypropylene, polyester and the like. Films that are acid-free films are preferred, as such films exhibit minimal effects on the image. A preferred film is polypropylene. It is understood that the nature of the image will have an effect on the choice of the polymer films e.g. photographic prints are susceptible to effects of acids, whereas other types of images e.g. prints, may be less sensitive.

The protective coating is a transparent coating, and is preferably scratch resistance and capable of being wiped to clean the surface. The coating conforms to the texture in the acrylic gel, and must be of a thickness that does not mask that texture. Examples of such coatings include acrylic coatings. The coating may have a gloss or matte finish.

A wide variety of substrates may be used. The substrates include flexible substrates e.g. paper, plastic films, canvas or the like. The substrates also include more rigid substrates e.g. cardboard, wood substrates e.g. hardboard or natural wood products, metal substrates e.g. aluminum, or the like. Batik, masonite, foam sheet, foam core or clipboard may also be used.

The adhesive must be transparent, in order to retain the aesthetic qualities of the print. In addition, the adhesive must be capable of bonding to the films and/or acrylic gel, as the case may be. Water-based adhesives should not be used.

The film should not exhibit shrinkage during the steps in the process involving heat. For instance, the film should exhibit a shrinkage of less than about 5%. The films should also be transparent, with minimal cloudiness. Preferably loss of transmission of light should be less than 10%. It is also preferred that the films be colourless, although in embodiments the films could be transparent but coloured (tinted). For example, one or more of the films could be tinted with sepia colours, especially if the print is black and white. Other colours could be used.

The gel is preferably an acrylic gloss gel. Acrylic matte gels could be used but are less transparent and more cloudy, and thus less preferred.

The present invention provides a textured image laminating film, particularly for use with prints, photographic images, posters, water colour paintings and other images, and to the laminated images that are obtained. The textured images may be on a wide variety of substrates, as discussed above. In addition to providing texturing, the laminating film also provides protection to the image.

The present invention is illustrated by the following examples.

### EXAMPLE 1

A polypropylene film having a thickness of 3 mil was coated with a heat-activated adhesive from 3 M. A release film was contacted with the adhesive.

Acrylic gloss gel from Tri-Art Manufacturing Inc. was applied to the polymer film and, using a press with a textured surface, imprinted with a texture that was random and with an appearance of being wrinkled or of a crumpled sheepskin. The gel was dried in an oven for 5-10 minutes at about 65-95° C. An acrylic coating was applied to the textured surface and air-dried.

The resultant textured laminating film was cut slightly larger than the size of a lithographic print on a hardboard substrate. The release sheet was peeled off the textured film, and the adhesive surface of the textured film was contacted with the print. The resultant sandwich was pressed at ambient temperature for 2-5 minutes using a mechanical press to effect bonding.

The resultant prints had the appearance of a print with a textured surface, resembling an oil painting.

The print does not necessarily have to pre-mounted on a substrate e.g. hardboard, but there is less tendency for wrinkling of the print if it is mounted.

1. A method of forming an image laminating film comprising:
a) applying a clear acrylic gel to a surface of a release sheet;
b) imprinting a texture to the clear acrylic gel;
c) heating the textured acrylic gel to dry the gel and retain a textured surface, the dried gel being transparent; and
d) applying to the surface of the gel an aqueous solution of a coating that forms a transparent protective layer conforming to the textured surface.

2. The method of claim 1 in which the coating of the protective layer is an acrylic coating.

3. The method of claim 2 in which the coating has a gloss surface.

4. The method of claim 2 in which the coating has a matte surface.

5. The method of claim 2 in which the coating of step (d) is dried at ambient temperature.

6. The method of claim 5 in which the protective layer is selected so that the image laminating film is colourless and transparent.

7. The method of claim 6 in which the acrylic gel applied in step (b) is an acrylic gloss gel.

8. The method of claim 7 in which an adhesive is applied to the release sheet prior to application of the acrylic gel.

9. The method of claim 8 in which the adhesive is a pressure-sensitive adhesive.

10. The method of claim 9 in which the adhesive selected so that the image laminating film so obtained is transparent and the release sheet is separable from the acrylic gel.

11. An image laminating film comprising:
a) a transparent acrylic gel on a release sheet, the gel having a textured surface imprinted therein and having been dried and the release sheet being separable from the acrylic gel; and
b) a transparent protective layer on the gel, the transparent protective layer being a coating.

12. The image laminating film of claim 11 in which there is an adhesive between the release sheet and the acrylic gel.

13. The image laminating film of claim 12 in which the adhesive is a pressure-sensitive adhesive.

14. The image laminating film of claim 12 in which the adhesive selected so that the image laminating film so obtained is transparent and the release sheet is separable from the acrylic gel.

15. The image laminating film of claim 12 in which the adhesive and protective layer are selected so that the image laminating film is colourless and transparent.

16. The image laminating film of claim 11 in which the protective layer is selected so that the image laminating film is colourless and transparent.

17. The image laminating film of claim 11 in which the adhesives and protective layer are selected so that the image laminating film is tinted and transparent.

18. The image laminating film of claim 17 in which the image laminating film is tinted with a sepia colour.

19. The image laminating film of claim 11 in which the acrylic gel is an acrylic gloss gel.
